(19) United States
(12) Patent Application Publication
(10) Pub. No.: US 2015/0092656 A1
(43) Pub. Date: Apr. 2, 2015

(54) APPARATUS AND METHOD FOR RESOURCE ALLOCATION TO SUPPORT DEVICE TO DEVICE BROADCAST AND GROUPCAST

(71) Applicant: Nokia Corporation, Espoo (FI)

(72) Inventors: Lars E. Lindh, Helsingfors (FI); Juha Sakari Korhonen, Espoo (FI); Zexian Li, Espoo (FI); Cassio Ribeiro, Espoo (FI); Vuokko Nurmela, Espoo (FI); Carl Wijting, Espoo (FI)

(21) Appl. No.: 14/499,082

(22) Filed: Sep. 26, 2014

Related U.S. Application Data
(60) Provisional application No. 61/883,828, filed on Sep. 27, 2013.

(51) Int. Cl. H04W 72/00; H04L 29/08; H04W 4/00

(52) U.S. Cl. CPC H04W 72/005; H04W 4/005; H04L 67/14
USPC 370/312

(57) ABSTRACT

One embodiment is directed to a method comprising determining to initiate a session; sending a first message over a channel in a subframe dedicated for initiating sessions; and transmitting an information indicating the resource where the next transmission of the session will happen.

### RELATED APPLICATIONS

This application relates to, and claims the benefit of U.S. Application filing No. 61/883828, entitled, “Apparatus and method for resource allocation to support device to device broadcast and groupcast”, filed on Sep. 27, 2013, which is hereby incorporated by reference in its entirety.

### TECHNICAL FIELD

The present application relates generally to an apparatus and a method for resource allocation to support device to device broadcast and groupcast.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application.

In wireless communication, different collections of communication protocols are available to provide different types of services and capabilities. Long term evolution, LTE, is one of such collection of wireless communication protocols that extends and improves the performance of existing universal mobile telecommunications system, UMTS, protocols and is specified by different releases of the standard by the 3^{rd} generation partnership project, 3GPP, in the area of mobile network technology. Other non-limiting example wireless communication protocols include global system for mobile, GSM, high speed packet access, HSPA, and worldwide interoperability for microwave access, WiMAX.

The improvements of LTE are being made to cope with continuing new requirements and the growing base of users. Goals of this broadly based project include improving communication efficiency, lowering costs, improving services, making use of new spectrum opportunities, and achieving better integration with other open standards and backwards compatibility with some existing infrastructure that is compliant with earlier standards. The project envisions a packet switched communications environment with support for such services as voice over IP, VoIP. The 3GPP LTE project is not itself a standard-generating effort, but will result in new recommendations for standards for the UMTS. Now the project moved to planning the next generation standards, sometimes referred to as LTE-Advanced, LTE-A.

A goal of LTE-A is to provide significantly enhanced services by means of higher data rates and lower latency with reduced cost. LTE-A is directed toward extending and optimizing the current 3GPP LTE radio access technologies to provide higher data rates at very low cost. LTE-A will be a more optimized radio system fulfilling the international telecommunication union radio communication sector, ITU-R, requirements for international mobile telecommunications-advanced, IMT-A, while maintaining backward compatibility with the current LTE release.

Integration of new network topologies into a cellular network may provide a context for certain embodiments of the present invention. Heterogeneous networks in LTE and LTE-A exemplify such integration. Heterogeneous network can include, for example, a deployment of macros, micros, picos, femtos and relays in the same spectrum. One step further is to allow direct communication between devices operating in the cellular system when communicating devices are close to each other to use radio resources in the most efficient manner. Device to device, D2D, has the potential benefits of user equipment power saving due to possible reduced transmission power, efficient radio resource reuse and offloading network burden. Different forms of D2D communication including unicast, groupcast and broadcast, have been defined.

### SUMMARY

Various aspects of examples of the invention are set out in the claims.

According to a first aspect of the present invention, a method may include by an apparatus, determining to initiate a session; sending a first message over a channel in a subframe dedicated for initiating sessions; and transmitting an information indicating the resource where the next transmission of the session will happen.

According to a second aspect of the present invention, an apparatus may include at least one processor, and at least one memory including computer program code, wherein the at least one memory and the computer program code configured to, with the at least one processor, cause the apparatus at least to determine to initiate a session; send a first message over a channel in a subframe dedicated for initiating sessions; and transmit an information indicating the resource where the next transmission of the session will happen.

According to a third aspect of the present invention, a computer program product comprising a computer-readable medium bearing computer program code embodied therein for use with a computer, the computer program code may include code for determining to initiate a session; code for sending a first message over a channel in a subframe dedicated for initiating sessions; and code for transmitting an information indicating the resource where the next transmission of the session will happen.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example wireless system in accordance with an example embodiment of the application in which the device-to-device, D2D, technology implements.

FIG. 2 illustrates an example of semi-static group resource allocation table in accordance with an example embodiment of the application.

FIG. 3 illustrates an example signaling exchange between a cluster head, CH, and user equipments, UEs, in accordance with an example embodiment of the application.

FIG. 4 illustrates an example procedure of the resource allocation and usage according to an example embodiment of the application.

FIG. 5 illustrates an example D2D frame structure according to an example embodiment of the application.

FIG. 6 shows an example structure of the multi-channel slotted Aloha in accordance with an example embodiment of the application.

FIG. 7 illustrates an example packet structure for the contention based broadcast/groupcast packet in accordance with an example embodiment of the application.

FIG. 8 illustrates a simplified block diagram of various example apparatuses that are suitable for use in practicing various example embodiments of this application.

### DETAILED DESCRIPTON

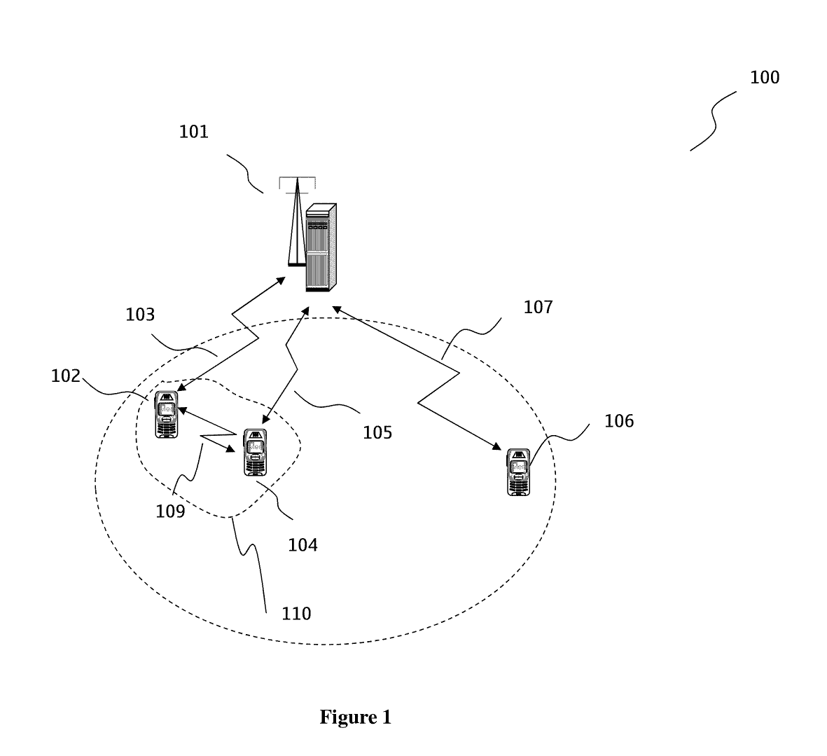

FIG. 1 illustrates an example wireless system 100 in accordance with an example embodiment of the application in which the device-to-device, D2D, technology implements. The example wireless system 100 comprises a network element, NE, such as for example, a 3^{rd} generation partnership project, 3GPP, macro cell evolved NodeB, eNB, 101 connecting to a core network that is not shown for brevity. In an example scenario, the NE 101 serves three user equipments, UEs 102, 104 and 106 via a communication path 103, 105, and 107, respectively. When the UEs 102 and 104 are being moved to be in close proximity to each other, for the sake of power saving, cost saving, and/or offloading of the core network etc., it may be necessary to put them into a D2D communication mode via a D2D communication path 109, for transporting traffic directly between the two UEs. In some example scenarios when there is no network coverage in the area where the devices are located, therefore the communication paths 103, 105, and 107 cannot be established, and the D2D communication path 109 is the only path available for information exchange between UEs 102 and 104. A D2D group 110 may be formed to include UEs 102 and 104. Although just one NE and three UEs are shown in FIG. 1, it is only for the purpose of illustration and the example wireless system 100 may comprise any number of NE(s), UE(s) and D2D group(s), and each D2D group may comprise any number of UE(s).

When considering design of the D2D broadcast and groupcast concepts, it needs to keep in mind that the proposed solution needs to be adapted to different scenarios with different levels of network coverage, which are, within network coverage, out of network coverage and partial network coverage. Here we denote by broadcast transmission as one transmission that are intended for any potential receiver in the coverage area, and groupcast transmissions are those that are intended for UEs belonging to a certain group. It should be noted that groupcast transmissions include a case where there are only two members in the group, which is one mechanism to implement unicast communications. Moreover, groupcast transmissions may be implemented as broadcast transmissions from physical layer point of view, with group identification and eventual restrictions implemented by higher layer protocols and procedures. The different scenarios of network coverage may yield various conditions and requirements on resource allocation and usage. For example, when out of network coverage, D2D transmissions may have to be contention based, while under network coverage, a scheduling based transmission may be preferable. With the fully contention based solutions, contention conflicts would affect the reliability and timely information exchange among group members, and lead to the inefficiency of supporting or inability to support a large number of UEs/groups, which in the worst case would cause significant amount of outage in the system. On the other hand, fully dynamic scheduling for group resources would lead to complex system design and it would require that the node providing scheduling is capable of supporting the related function. Therefore, the resource allocation and usage for D2D broadcast and groupcast needs to be carefully designed by taking into account the pros and cons of both contention based and scheduling based schemes.

In an example embodiment, a resource allocation framework may be based on a two stage resource allocation scheme where resources are allocated semi-statically for the D2D groups while UEs within a group are dynamically assigned to their corresponding group resources, when those resources are actually used for transmission by one of the UEs. The dynamical assignment of resource for individual UE may be contention based, scheduling based, or in a combined manner. This will be further illustrated by various example embodiments below.

In an example embodiment, a cluster is defined to comprise multiple D2D groups and a cluster head, CH, is appointed. In general, the functionalities of the cluster head can be classified as acting as a timing reference and providing resource configuration, for example, providing frame structure, frame number, semi-static configuration of group resources, and so on.

In an example embodiment, the cluster head may also have the functionality of scheduling dynamic resource allocation for UEs to solve the problem of conflicting resource requests from UEs, either belonging to the same group or not, and to assign the transmitting UE the group resources within the area covered by the cluster.

Even though the cluster head is usually assumed to support extra functionalities, it is not reasonable to assume that it can perform all functions regularly provided by an eNB. The cluster head may be a truck-mounted device, for example, for firefighters operating in an accident scene, or else a regular public safety UE, in which case the constraints due to battery powered operations are evident. Hence, it is important to minimize complexity of cluster head and its related functions. It should be noted that in case there is network coverage, the eNB can take the role of cluster head.

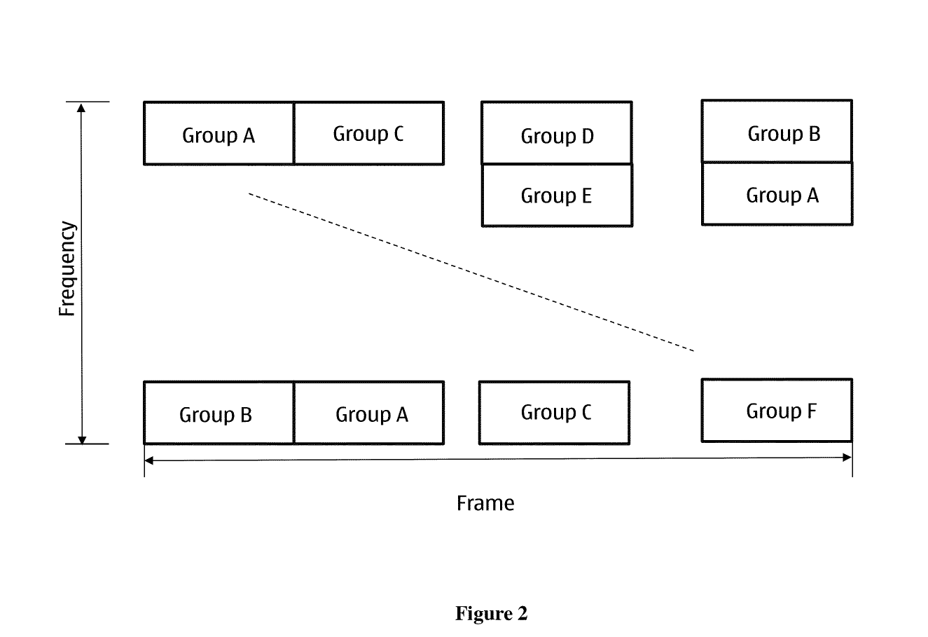

FIG. 2 illustrates an example of semi-static group resource allocation table in accordance with an example embodiment of the application. In the example of FIG. 2, the regular cellular frame structure, such as for example, the long term evolution, LTE, frame structure, is reused for D2D resource allocation. The cluster head may indicate the semi-static group resource allocation table to all the D2D groups under its coverage. By “semi-static”, it means that the CH schedules a resource for a group with some predefined starting point in time and being valid for a predefined time duration, for example, N frames where N≧1, or until it is replaced by another configuration. The CH may define a certain amount of resource blocks, such as for example, the LTE physical resource block, PRBs, for each group, taking into account the required data rates, for example VoIP service or video communications. For example, all the blocks marked with “Group A” in FIG. 2 are the resource blocks allocated to D2D group A. There can be multiple resource blocks for a group within the frame. All UEs connected to the CH will get the resource allocation table in the way of broadcasting or unicasting before starting transmitting in the group. For scenarios where UEs are within network coverage, the resource allocation table may be informed by the eNB as well.

While the resources for group communication are semi-statically allocated by the CH, the grants for the transmitting UE are given dynamically. When one UE within a certain group wishes to transmit data to other members, firstly it will send a scheduling request to the CH. For example, in the case of a push to talk, PTT, application, the scheduling request may be triggered by the action of pushing the talk button. For video or photo sharing applications, the transmission itself may take several frames and performed as a background task in the device.

In an example embodiment, the request phase may be essentially contention based in the sense that the UE sends the request on a common resource, which could potentially also be used by some other UE with a certain collision probability, and that it will result in at least one unrecognized request as a consequence. There are different ways for a UE to select the resource. In one example embodiment, it could be based on a random number and in another example embodiment, it could be derived from a user identity, ID, if available, and in yet another embodiment it could be derived from the traffic type or some combination thereof. In another example embodiment, the request phase may be contention-free with cluster head pre-allocated user specific resources for the requests. However, this contention-free approach may mean consuming more radio resources for requests or may increase complexity of processing in cluster head, as it has to search for transmissions in different resources including different sequences.

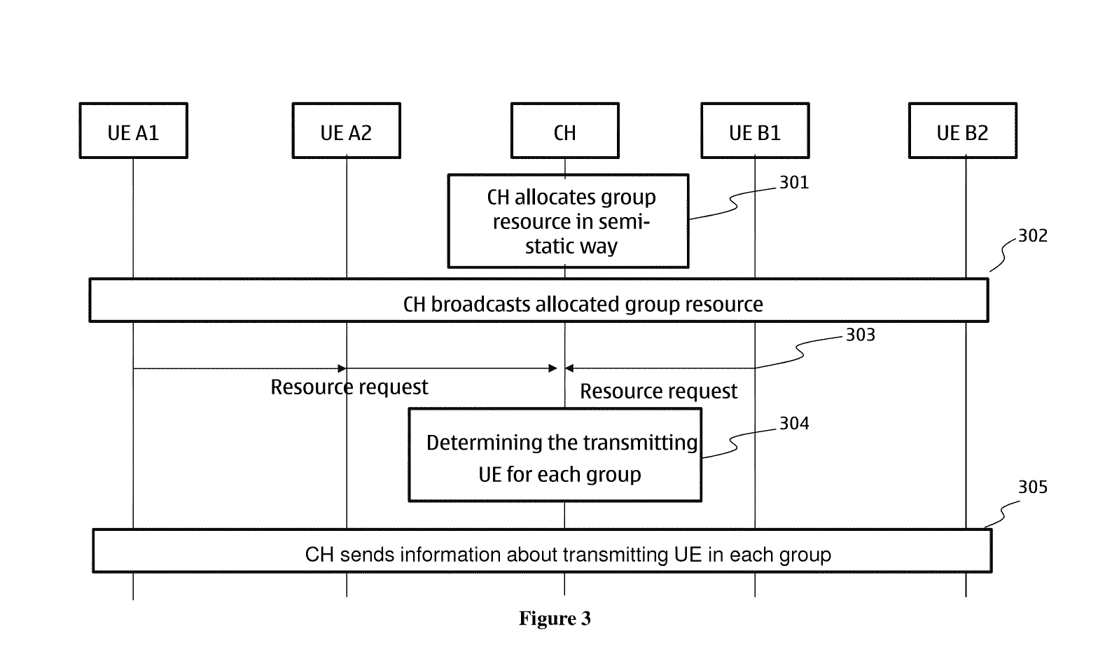

In case there is more than one UE within the same group requesting resources, CH will decide who can take the following resources. FIG. 3 illustrates an example signaling exchange between the CH and the UEs in accordance with an example embodiment of the application. In FIG. 3, it is assumed that UE A1 and UE A2 belong to D2D Group A, and UE B1 and UE B2 belong to Group B. Based on the need, CH will allocate orthogonal resources to different D2D groups in a semi-static manner at 301. The CH can broadcast the resource allocation table to all UEs connected to it at 302. In FIG. 3, at 303, it is assumed that both UE A1 and UE A2 want to get resource for transmission, and UE B1 from Group B sends out resource request as well. At 304, since there is no collision on resource requests in Group B, UE B1 will receive the grant to transmit data. However, there is collision in Group A, and the CH will choose the transmitter between UE A1 and UE A2. For example UE A2 will get the transmission opportunity. Then CH can send the information about who is the transmitter in each group at 305. All UEs connected to the CH will read the allocations given by the CH. A UE may go to power saving mode if no message is received indicating that a transmission is active for its group. Alternatively, it is possible to have an explicit indication of “empty allocation” to help receiving-only UEs.

In an example embodiment, the resource request message may be a common sequence for a group and UE attaching its ID information after the sequence. After detecting the ID information, the CH will know which UE has sent the resource request message. Alternatively, the resource request message may contain UE specific sequence, such as for example, using different time/frequency resource or/and different sequence, as UE identifier to CH.

In an example embodiment, the information sent at 305 regarding the transmitting UE may comprise two parts: an assignment message for a group of UEs using a group-specific identity, which may indicate which group has active transmission in the next transmission opportunity; and a grant message to the transmitting UE within each group with active transmissions in the next transmission opportunity. The cyclic redundancy check, CRC, of the assignment message can be scrambled with a common identity or a group-specific identity, and it can be based on existing formats for resource allocation, such as for example, the LTE format. The grant message for the transmitting UE needs to identify both the UE itself as well as the group to which the transmission is intended.

In an example embodiment, assuming that the transmitting UE can successfully decode both the grant and assignment messages, the CRC of the grant message can be scrambled with a UE-specific identity. In this scenario, the assignment message may carry the resource information, while the grant message may indicate the group which the transmission is intended to. If the transmitting UE cannot be assumed to be able to decode both messages successfully, the resource allocation needs to be indicated in both messages. In another example embodiment, the CRC of the grant message is scrambled with UE-specific identity and group-specific identity. In this case, the group can be identified by the UE during the blind search for the control message itself. The grant message can be formed in different ways. In an example embodiment, it can be same as the assignment message so it can provide more robustness for the transmission given that the transmitting UE would be able to transmit even if it fails to receive the assignment message. In another example embodiment, the grant message can be formed in a more compact way to reduce the overhead in air interface or utilize a more robust coding for the grant message itself. Since two identities are used to scramble the same message, it may bring the problem that there are multiple combinations of identities that could lead to the same result. The most trivial example is that the scrambling with UE ID=11 and Group ID=00 cannot be distinguished from that with UE ID=00 and Group ID=11. Therefore, such a double masking scheme may imply strict management of the feasible ID values and reduction of the possible ID spaces. This complexity can be avoided by strictly separating the scrambling bits into a set identifying the group ID and another set identifying UE ID. For example, for the same 16-bit CRC length as in LTE, the group ID could occupy the first 5 bits, while the UE ID could be reduced to the remaining 11 bits. This would still allow identification of 32 groups and 2048 UEs in a certain area, which should be enough for Public Safety needs. Another possibility is to use larger CRC field, in which case more bits can be allocated to group and/or UE IDs.

In case a restriction rule is applied that each UE can only request transmission to one group at a time, the grant message only needs to identify the transmitting UE, as the corresponding group is already known implicitly.

In an example embodiment, if the resources for the group are known a priori due to the semi-static allocation of group resources, the assignment or/and grant message may not need to specify the resource, and hence compact messages can be used by default.

In an example embodiment, there may be one single joint message for assignment and grant information. The CRC of the joint message may be scrambled with group-specific identity, and the message contains the ID of the transmitting UE instead of indication of resources for transmission. This allows a short message, as the resources are known a priori due to the semi-static allocation of resources to the group.

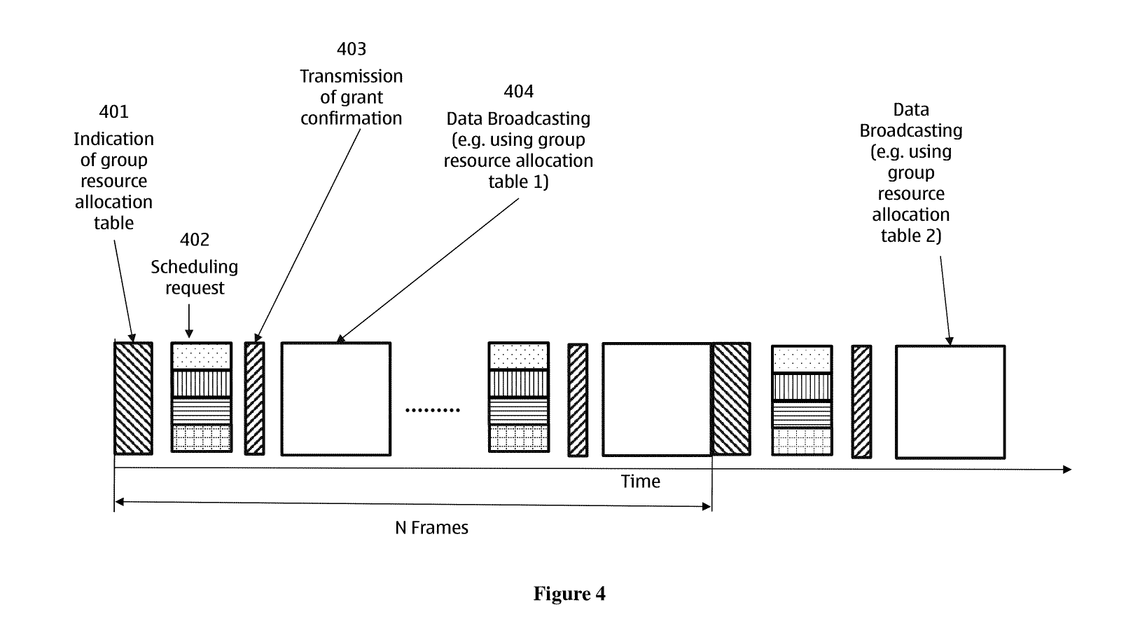

FIG. 4 illustrates an example procedure of the resource allocation and usage according to an example embodiment of the application. The procedure is divided into four phases in FIG. 4: indication phase 401 of group resource allocation table from CH, scheduling request phase 402 from UEs (4 UEs/groups listed as an example) to CH, transmission grant confirmation phase 403 from CH, and data broadcast phase 404 from transmitting UE. Since the group resource allocation is semi-static for, e.g., N frames, there would normally be several scheduling request, transmission grant confirmation, and data broadcast phases between consecutive indication phases of group resource allocation table.

The receiving UE behavior can be specified such that UEs may also attempt to decode potential transmissions to their own groups even if no assignment messages are received, in order to increase robustness. This is only feasible in case the transmission parameters for the group are also semi-statically configured, e.g. modulation and coding scheme, or if the transmission itself contains a header with the required information. In this case the transmission of the assignment message itself can be considered as optional.

In an example embodiment, the CH still allocates the resources to different groups in semi-static way, but CH is not responsible for resource usage within the group. Instead, there can be a “group head” within the group who is responsible for scheduling UEs within the same group. The group heads would need to follow timing reference given by cluster head, if operating on the same carrier. Another possibility is that the UEs may be assigned the resource with a contention based scheme, which will be further illustrated in detail by various example embodiments below.

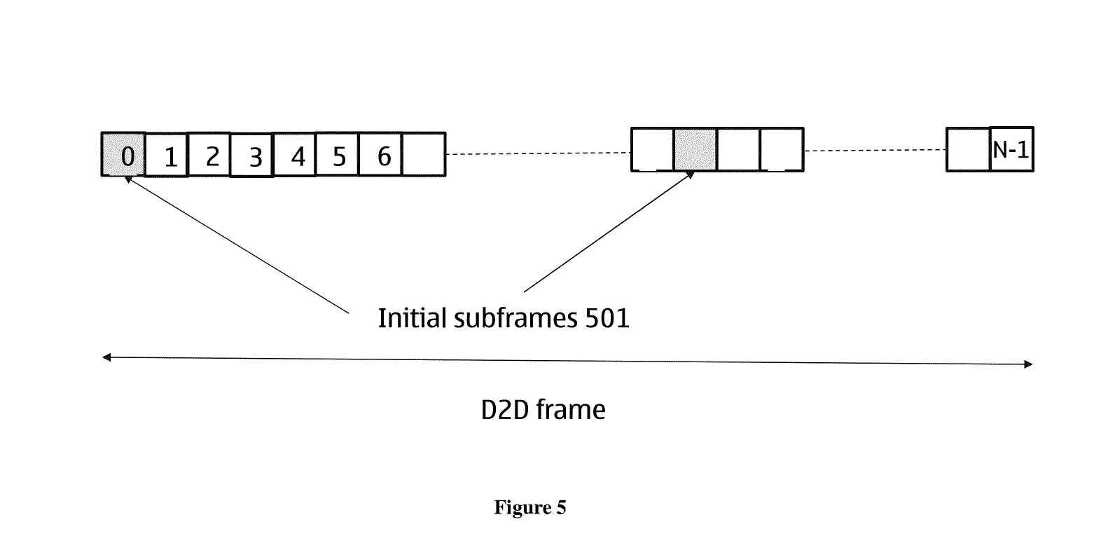

In an example embodiment, an enhanced multi-channel slotted Aloha protocol based scheme can be utilized, where the UEs compete for the resource and resources are assigned by contention and collective agreement between the UEs according to an enhanced multi-channel slotted Aloha scheme. This scheme may be especially beneficial to PTT type of applications where there is a well-defined starting point (“pushing the button”) and well defined end point (releasing the button). Also file transfer and other protocols can benefit nicely from the enhancement. In this scenario, it is assumed that all UEs have a common understanding about slot numbers, or in the context of LTE system, the subframe numbers. In addition to the basic synchronization, the CH transmits a special start of D2D-frame synchronization mark, where a D2D-frame consists of N subframes, as illustrated by FIG. 5 as one example.

When a UE wants to initiate a session (e.g, in PTT, “the user presses the button”) it sends its first broadcast or groupcast packet only in certain predefined subframes, denoted as initial subframes 501 in FIG. 5. In an example embodiment, each D2D group may have dedicated initial subframes. The initial subframes can be assigned by the CH or alternatively be predefined. Only UEs that want to initiate a session are allowed to transmit in these subframes. The idle UEs, which are not presently participating in any broadcast or groupcast sessions, can sleep in all other subframes except in these predefined initial subframes. This may save power for the UEs. UEs that already are active in some session refrain from transmitting in these subframes unless they are initiating a new session themselves. Instead they may listen to the channel for newly initiated sessions. This can lead to a higher probability of a successful transmission without a collision in a congested network, since these subframes are reserved only for initiating sessions. The UEs transmit their messages in a random channel in the initial subframe.

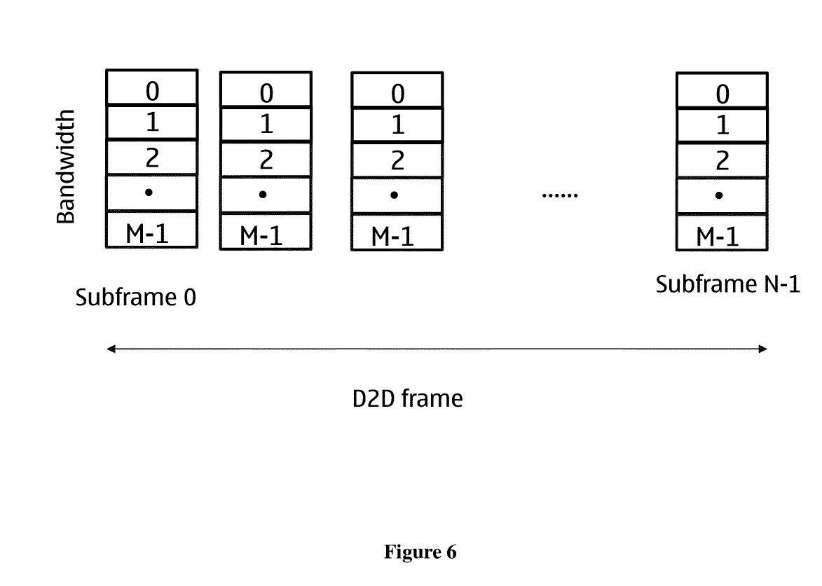

In an example embodiment, one frame of multi-channel slotted Aloha consists of N subframes, where the bandwidth is divided into a number of M channels. A subframe and channel is referred to as resource. FIG. 6 shows an example structure of the multi-channel slotted Aloha in accordance with an example embodiment of the application. In an example embodiment, frequency hopping may be utilized, where the position of the channels change in frequency as a function of the subframe. This will give frequency diversity to the transmission. In another example embodiment, the slotted Aloha channels may be permutated over the subfames and each channel would be spread over the whole bandwidth.

In an example embodiment, if a UE from a group has initiated a session announced in an initial subframe, all UEs of that group will remain in active mode to receive the communication. It is assumed that all transmitted broadcast and groupcast packets consist of a header and a data part. The header may be transmitted with a predefined robust modulation and coding scheme but the communication parameters for the data are signaled in the header. In addition to the basic communication parameters there may be a small number of bits indicating in a relative way in which subframe or/and channel the next transmission of the session will happen. All active UEs may decode the header in all subframes and channels, and may take this information into account when contending for a transmission. In particular, no other UE should transmit in the reserved subframe and channel indicated by the allocation bits. This will reduce the number of collisions significantly. It is further assumed that the transmitting UE does not indicate any subframe/channel resources already reserved by other UEs. After the UE which initiated the session completes its data transmission, the nodes of the group can return to idle mode to save energy.

If the first transmission of session has a collision for some of the UEs receiving data in that broadcast group, the receivers observing the collision might lose the first transmission itself and then potentially all the subsequent transmissions that are addressed by the initial transmission. In case there is a control loop defined at higher layers, the inactivity for this session will be noted and the transmitting UE will be requested to re-initiate the session. For cases where such control loop is not available or not fast enough, e.g. real time voice services, it is important to properly dimension the frame structure and the number of reserved transmission subframes after initial transmission in order to keep the outage level under control. For real time voice service the UE could potentially transmit some of the packets periodically in the initial subframes in order to invite UEs that might have missed the first opportunity or joined later.

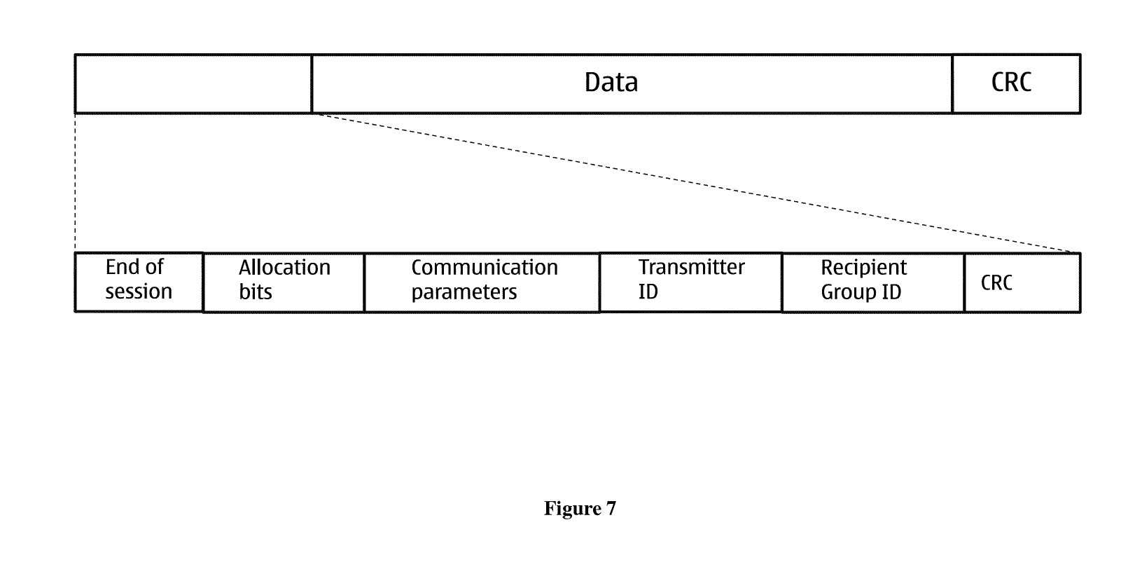

FIG. 7 illustrates an example packet structure for the contention based broadcast/groupcast packet in accordance with an example embodiment of the application. In FIG. 7, the packet comprises a header part and a data part. The header, which may be transmitted with robust coding and modulation scheme, may contain some basic parameters for the transmission, such as for example, the IDs of transmitting UE and the recipient group, communication parameters for the data and an end of session indicator. Both the header and the data have CRCs for checking the integrity of the received bits. The active UE tries to decode the header in all subframes and channels. If the CRC of the header does not check, the receiving UE may assume that there was no packet or potentially a collision. If the CRC checks and the receiving UE belongs to the recipient group, it also decodes the data part of the packet. By the field “Allocation bits”, the transmitting UE may indicate in which resource (in terms of subframe and/or channel) it will transmit the next packet(s). All UEs receiving this packet will neither contend nor reserve the reserved resource. In an example embodiment, an optimization of the scheme would be to observe the channel already x ms (x>=0) before the initial subframe and adjust the scheduling of the next transmission with this information. If the UE is not aware of any preferred future resource to transmit in, a pre-defined value will be indicated, for example “0”. In this case the UE will listen to other UEs' reservation and contend in a vacant resource. With the allocation bits the relative future subframe numbers can be encoded as k1, k2, k3, . . . kmax. The number of allocation bits and the corresponding kmax may be pre-configurable parameters. The channel number may also be reserved with the allocation bits. The exact number of bits and values of the k1, k2, . . . kmax variables may be dependent on N, M and the system topology. The range of the k-values could be between a few subframes up to one hundred subframes. It should be noted that the invention is not limited to the parameters listed above and they are only for illustration purpose. For example, in an alternate embodiment, the “End of session” indication is incorporated in the “Allocation bits” field by assigning a predefined value to the “Allocation bit” field to indicate an end of session. A different predefined value would be assigned to indicate that the next transmission time is unknown.

Higher layers in the UE can monitor the traffic and in case of high traffic or a congested network, back-off can be introduced so a UE may only contend and make reservations with a certain probability. Optionally the implementation could be optimized by allowing receiving UEs to sleep in between of transmissions. UEs may just need to listen to the initial subframes and the next scheduled subframe in their group. This optimization is a trade-off between gains from sleep mode versus impact on the overall system performance by increased number of collisions. The increased number of collisions would be realized assuming that, when a UE completes its transmissions (session ends), one of the UEs in the group would usually immediately initiate a new session. If the new session is initiated by a UE that has not decoded allocation bits continuously but has been sleeping between the scheduled subframes during the earlier sessions, it would not know which resources are free and would choose its resource blindly, if allowed to do so rather than forced to delay the start of the session and collect allocation information long enough in order to minimize the risk of collisions.

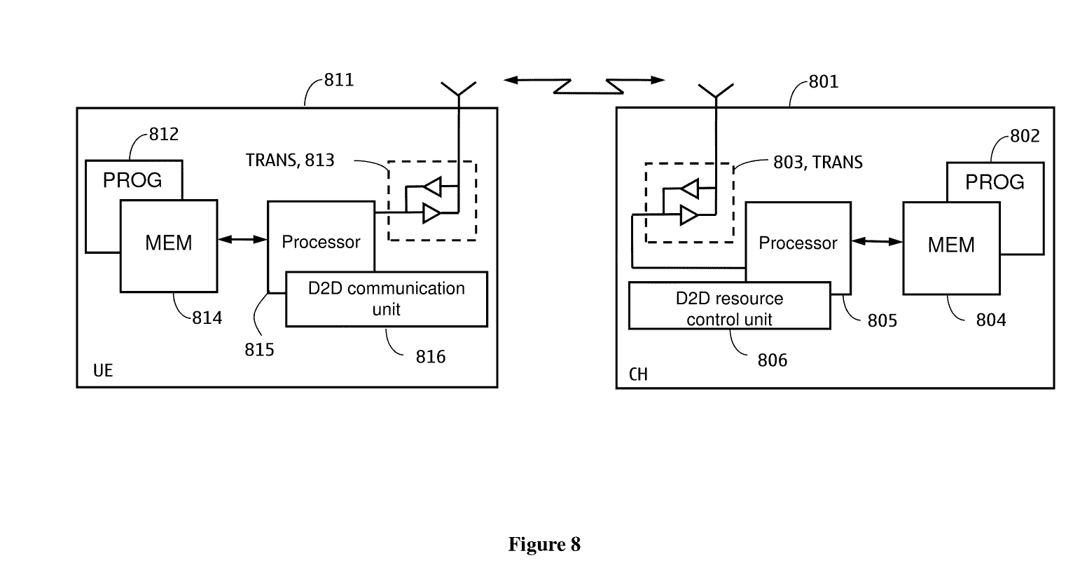

Reference is made to FIG. 8 for illustrating a simplified block diagram of various example apparatuses that are suitable for use in practicing various example embodiments of this application. In FIG. 8, a cluster head 801 is adapted for communication with a UE 811. The UE 811 may be in vicinity of another UE, which is not shown in FIG. 8 for simplicity, and can communicate in D2D mode with the other UE. The UE 811 includes at least one processor 815, at least one memory (MEM) 814 coupled to the at least one processor 815, and a suitable transceiver (TRANS) 813 (having a transmitter (TX) and a receiver (RX)) coupled to the at least one processor 815. The at least one MEM 814 stores a program (PROG) 812. The TRANS 813 is for bidirectional wireless communications with the CH 801.

The CH 801 includes at least one processor 805, at least one memory (MEM) 804 coupled to the at least one processor 805, and a suitable transceiver (TRANS) 803 (having a transmitter (TX) and a receiver (RX)) coupled to the at least one processor 805. The at least one MEM 804 stores a program (PROG) 802. The TRANS 803 is for bidirectional wireless communications with the UE 811. The CH 801 may be coupled to one or more cellular networks or systems, which is not shown in this figure.

As shown in FIG. 8, the CH 801 may further include a D2D resource control unit 806. The unit 806, together with the at least one processor 805 and the PROG 802, may be utilized by the CH 801 in conjunction with various example embodiments of the application, as described herein.

As shown in FIG. 8, the UE 811 may further include a D2D communication unit 816. The unit 816, together with the at least one processor 815 and the PROG 812, may be utilized by the UE 811 in conjunction with various example embodiments of the application, as described herein.

At least one of the PROGs 802 and 812 is assumed to include program instructions that, when executed by the associated processor, enable the electronic apparatus to operate in accordance with the example embodiments of this disclosure, as discussed herein.

In general, the various example embodiments of the apparatus 811 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The example embodiments of this disclosure may be implemented by computer software or computer program code executable by one or more of the processors 805, 815 of the CH 801 and the UE 811, or by hardware, or by a combination of software and hardware.

The MEMs 804 and 814 may be of any type suitable to the local technical environment and may be implemented using any suitable data storage technology, such as semiconductor-based memory devices, flash memory, magnetic memory devices and systems, optical memory devices and systems, fixed memory and removable memory, as non-limiting examples. The processors 805 and 815 may be of any type suitable to the local technical environment, and may include one or more of general purpose computers, special purpose computers, microprocessors, digital signal processors (DSPs) and processors based on multi-core processor architecture, as non-limiting examples.

Without in any way limiting the scope, interpretation, or application of the claims appearing below, a technical effect of one or more of the example embodiments disclosed herein may be simplifying CH design to achieve similar solution for both with network coverage and without network coverage. This helps to support a large amount of groups easily and scale group resources to different traffic needs, e.g. some groups with voice-only, other groups with video streaming, etc. Another technical effect may be supporting a compact signaling scheme and balancing the robustness and signaling efficiency. Moreover, the contention probability may be reduced, especially for the proposed contention based scheme. Thus, a higher efficiency due to the lower collision rates can be achieved.

Embodiments of the present invention may be implemented in software, hardware, application logic or a combination of software, hardware and application logic. The software, application logic and/or hardware may reside on an apparatus such as a user equipment, a CH, a NodeB or other mobile communication devices. If desired, part of the software, application logic and/or hardware may reside on a CH 801, part of the software, application logic and/or hardware may reside on a UE 811, and part of the software, application logic and/or hardware may reside on other chipset or integrated circuit. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

It is also noted herein that while the above describes example embodiments of the invention, these descriptions should not be viewed in a limiting sense. Rather, there are several variations and modifications which may be made without departing from the scope of the present invention as defined in the appended claims.

For example, it has been assumed that there is only one UE within the group that can transmit data for a certain group in order to reduce the signaling overhead and the complexity of CH. It is straightforward to generalize the idea to cover the case where there are more than one UE from the same group to get the resource for transmission. Moreover, the description so far has focused in a scenario where only one carrier is available for D2D communications. In case multiple carriers are available, it is possible to let each group communicate in separate carriers, thus minimizing cross-interference due to transmitter and receiver non-idealities. In this case, it is possible that each carrier utilizes a different device as cluster head, or that the same device acts as cluster head in different carriers. If the UEs can be assumed to listen to transmissions in multiple carriers, it is also possible to have the cluster head operating only in one carrier, with the group resources mapped to their corresponding carriers.

Further, the various names used for the described parameters are not intended to be limiting in any respect, as these parameters may be identified by any suitable names.

If desired, the different functions discussed herein may be performed in a different order and/or concurrently with each other. Furthermore, if desired, one or more of the above-described functions may be optional or may be combined. As such, the foregoing description should be considered as merely illustrative of the principles, teachings and example embodiments of this invention, and not in limitation thereof.

We claim:

1. A method, comprising:
by an apparatus,
determining to initiate a session;
sending a first message over a channel in a subframe dedicated for initiating sessions; and
transmitting an information indicating the resource where the next transmission of the session will happen.

2. The method according to claim 1, wherein the apparatus is in a device to device mode, and the first message is one of broadcast, groupcast, and unicast message to one or more entity.

3. The method according to claim 1, wherein the first message comprises a header and a data part.

4. The method according to claim 3, wherein the header is transmitted prior to the data part with a predefined robust transmission scheme and includes a communication parameter for the data.

5. The method according to claim 3, wherein the information indicating the resource where the next transmission will happen is included in the header.

6. The method according to claim 1, wherein the information indicating the resource where the next transmission will happen is one bit indicating whether the resource is the same as for the current transmission.

7. The method according to claim 1, further comprising:
transmitting a second information indicating the end of the session.

8. The method according to claim 1, wherein when the apparatus acting as a receiving entity, further comprising:
listening to the channel only in the subframe dedicated for initiating sessions.

9. An apparatus, comprising:
at least one processor;
and at least one memory including computer program code,
wherein the at least one memory and the computer program code are configured to, with the at least one processor, cause the apparatus at least to:
determine to initiate a session;
send a first message over a channel in a subframe dedicated for initiating sessions; and
transmit an information indicating the resource where the next transmission of the session will happen.

10. The apparatus according to claim 9, wherein the apparatus is in a device to device mode, and the first message is one of broadcast, groupcast, and unicast message to one or more entity.

11. The apparatus according to claim 9, wherein the first message comprises a header and a data part.

12. The apparatus according to claim 11, wherein the header is transmitted prior to the data part with a predefined robust transmission scheme and includes a communication parameter for the data.

13. The apparatus according to claim 11, wherein the information indicating the resource where the next transmission will happen is included in the header.

14. The apparatus according to claim 9, wherein the information indicating the resource where the next transmission will happen is one bit indicating whether the resource is the same as for the current transmission.

15. The apparatus according to claim 9, wherein the at least one memory and the computer program code are configured to, with the at least one processor, cause the apparatus at least further to:
transmit a second information indicating the end of the session.

16. The apparatus according to claim 9, wherein when the apparatus acting as a receiving entity, the at least one memory and the computer program code are configured to, with the at least one processor, cause the apparatus at least further to:
listen to the channel only in the subframe dedicated for initiating sessions.

17. A computer program product comprising a computer-readable medium bearing computer program code embodied therein for use with a computer, the computer program code comprising:
code for determining to initiate a session by an apparatus;
code for sending a first message over a channel in a subframe dedicated for initiating sessions; and
code for transmitting an information indicating the resource where the next transmission of the session will happen.

18. The computer program product according to claim 17, wherein the information indicating the resource where the next transmission will happen is one bit indicating whether the resource is the same as for the current transmission.

19. The computer program product according to claim 17, further comprising:
code for transmitting a second information indicating the end of the session.

20. The computer program product according to claim 17, wherein when the apparatus acting as a receiving entity, further comprising:
code for listening to the channel only in the subframe dedicated for initiating sessions.
